(19) United States
(12) Patent Application Publication
(10) Pub. No.: US 2004/0008532 A1
(43) Pub. Date: Jan. 15, 2004

(54) Power supply device

(75) Inventor: Katsuya Asawa, Matsumoto (JP)

Correspondence Address: KODA & ANDROLIA, 2029 CENTURY PARK EAST, SUITE 1430, LOS ANGELES, CA, 90067-3024, US

(73) Assignee: IZUMI PRODUCTS COMPANY

(21) Appl. No.: 10/615,058

(22) Filed: Jul. 8, 2003

(30) Foreign Application Priority Data
Jul. 9, 2002 (JP) 2002-199945

(51) Int. Cl. H02M 1/00

(52) U.S. Cl. 363/147; 363/146

(57) ABSTRACT

A power supply device including an inner assembly body that contains a power supply circuit and primary-side and secondary-side connecting elements which are electrically connected to the power supply circuit, the inner assembly being processed by insert-molding so that the outer surface of the inner assembly body is covered by a synthetic resin that is integral with the inner assembly body. The inner assembly body can be obtained by an inner case formed by an inner case half-body and an inner case cover so as to have a hollow space inside having the power supply circuit, and the primary-side and secondary-side connecting element are sealed in or integrally attached to this inner case.

### BACKGROUND OF THE INVENTION

1. Field of the Invention

The present invention relates to a power supply device such as an AC adapter, etc.

2. Prior Art

AC adapters are widely used in electronic equipment, etc. They convert commercial alternating-current power supplies into direct-current power supplies that have a specified voltage value.

FIG. 7 shows an example of a power supply device that is generally utilized as an AC adapter.

In FIG. 7, the reference numeral 10 is an outer case of the AC adapter, 12 are plug blades connected to the socket of a commercial power supply (or power outlet, for instance), and 14 is a cord. The AC adapter contains direct current converter circuit elements (not shown) such as a transformer, rectifier, etc. in the main body, and it is covered by a case made of a synthetic resin so that these circuit elements are sealed.

However, conventional power supply devices such as AC adapters, etc. are manufactured by an assembly method in which the inner assembly body accommodating the power supply circuit is set in an outer case and sealed by being covered by this case. Accordingly, the number of parts required is large; and since assembly is accomplished by means of an outer case, the product cannot be made sufficiently compact. In addition, the external shape of the product is limited, so that the degree of freedom in designing the product is hindered. Moreover, since sealing is done by an outer case, the product does not have sufficient waterproof properties.

### SUMMARY OF THE INVENTION

The present invention is to solve the problems seen in the prior power supply devices.

The object of the present invention is to provide a power supply device which allows the free design of the external shape, etc. of the product, so that products of various configurations can easily be provided and to provide a power supply device which is enhanced with waterproof properties so that the device can be provided as a highly reliable device.

The above object is accomplished by a unique structure of the present invention for a power supply device that comprises an inner assembly body which contains a power supply circuit and a primary-side connecting element and a secondary-side connecting element which are electrically connected to the power supply circuit, and this inner assembly is insert-molded, so that the outer surface of the inner assembly body is covered by a synthetic resin that is integral with the inner assembly body.

In this structure, the inner assembly body is comprised of an inner case formed by an inner case half-body and an inner case cover so as to have a hollow space therein with the power supply circuit provided therein, and the primary-side connecting element and the secondary-side connecting element are sealed in or integrally attached to the inner case. The inner assembly body can be formed so that an inner case half-body in which the power supply circuit is accommodated and is filled with a potting resin, and the power supply circuit is embedded in this potting resin. Also, the inner assembly body can be comprised of a power supply circuit embedded in a potting resin that is formed in a desired shape.

In the above structure, the power supply circuit includes a direct current converter circuit provided on a printed circuit board, and such a direct current converter circuit is a transformer, a diode, etc.

### BRIEF DESCRIPTION OF THE DRAWINGS

FIG. 1 is a perspective view that shows the construction of one embodiment of the power supply device according to the present invention;

FIG. 2 is a sectional view that shows the internal structure thereof;

FIG. 3 is a perspective view of the inner assembly body;

FIG. 4 is an explanatory diagram that shows the inner assembly body viewed from the side to which the cord bush is attached;

FIG. 5 is a sectional view of another example of the construction of the inner assembly body;

FIG. 6 is a perspective view of still another example of the construction of the inner assembly body; and

FIG. 7 is a perspective view of a conventional AC adapter.

### DETAILED DESCRIPTION OF THE INVENTION

Preferred embodiments of the present invention will be described in detail below.

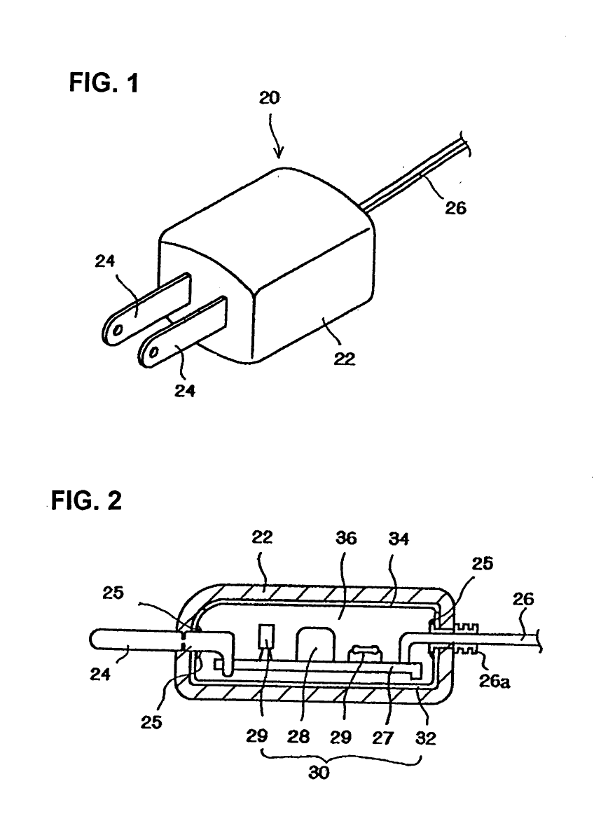

FIG. 1 shows an AC adapter 20 according to one embodiment of the power supply device of the present invention. The reference numeral 22 is an outer case which is formed as a block by integral molding of a synthetic resin. Plug blades 24 which are inserted into the socket of a commercial power supply (or power outlet) extend from one end of the outer case 22 as a primary-side side connecting element, and a cord 26 extends from the other end as a secondary-side side connecting element. The cord 26 is connected to a power supply input terminal of an electronic device during use.

The AC adapter 20 of the shown embodiment is characterized in that this adapter contains a printed circuit board assembly which includes (as a power supply circuit) a direct-current converter circuit that outputs a commercial alternating-current power supply voltage as a constant direct-current voltage, and an inner assembly body that accommodates this printed circuit board assembly is molded by a synthetic resin by insert-molding, so that the outer surface of the inner assembly body is integrally formed and covered by an outer case 22 consisting of a synthetic resin.

FIG. 2 shows the internal structure of the AC adapter 20.

A specified electric circuit elements 29 such as a transformer 28, diodes 29, etc. are mounted on a printed circuit board 27, thus forming a printed circuit board assembly 30, and this printed circuit board assembly 30 is sealed by an inner case half-body 32 and an inner case cover 34, thus forming an inner assembly body 36; after which the inner assembly body 36 is insert-molded using a synthetic resin, thus covering the outer surface of the inner assembly body 36 by an outer case 22 that is formed by such a insert-molding that uses the synthetic resin. The inner case half-body 32 and the inner case cover 34 are made of a material that has electrically insulating properties such as a resin, etc.

As shown in FIG. 2, the plug blades 24 and cord 26 are connected to the printed circuit board assembly 30. In the shown embodiment, the plug blades 24 are connected to one end of the printed circuit board 27, and the cord 26 is connected to another end of the printed circuit board 27. Upon sealing the printed circuit board assembly 30 by the inner case half-body 32 and inner case cover 34, the tip ends of the plug blades 24 are set to protrude from the inner case half-body 32, and the cord 26 is passed through a through-hole formed in the inner case half-body 32. The inner case cover 34 is securely attached to the inner case half-body 32, thus forming the inner case.

Slit holes through which the plug blades 24 pass are formed in the inner case half-body 32 in alignment with the positions where the plug blades 24 are passed through. With the plug blades 24 passed through the slit holes, the edges of the slit holes are coated with an adhesive agent 25, so that the plug blades 24 are sealed and fastened to the inner case half-body 32.

The cord 26 is fastened in place by passing a cord bush 26a, which is mounted on to the cord 26, through a hole formed in the inner case half-body 32, and the cord bush 26a is sealed to the inside surface of the inner case half-body 32 by an adhesive agent 25 applied on the inside surface of the inner case half-body 32.

The inner assembly body 36 is completed for assembly by tightly attaching the inner case cover 34 to the opening of the inner assembly body 36 after the printed circuit board assembly 30, plug blades 24 and cord 26 have been set in the inner case half-body 32. The inner case half-body 32 and the inner case cover 34 are attached together by, for instance, ultrasonic sealing.

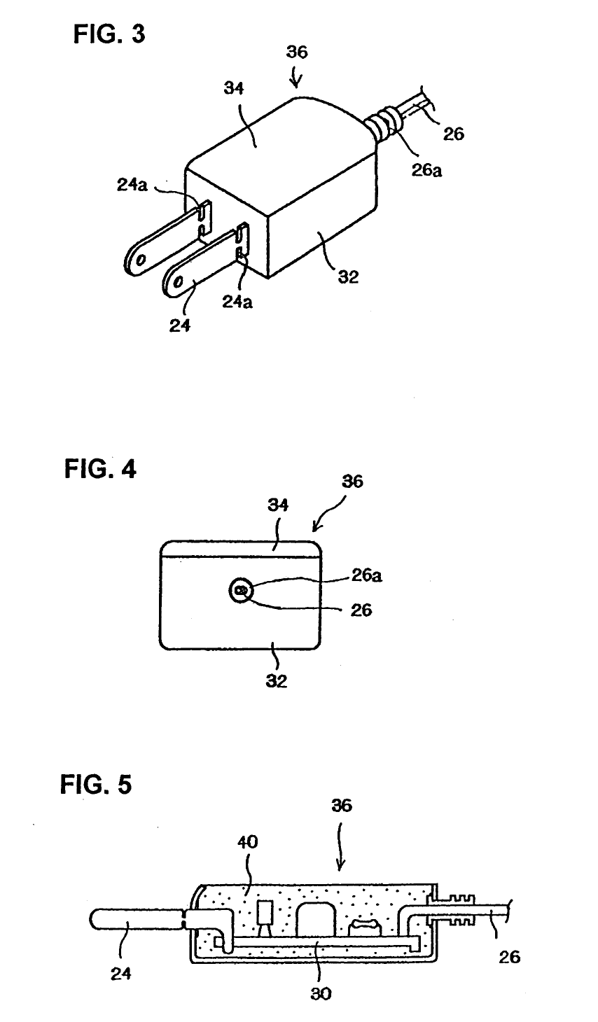

FIG. 3 shows the inner assembly body 36 formed by tightly attaching the inner case cover 34 to the inner case half-body 32. The plug blades 24 extend from one side of the inner assembly body 36, and the cord 26 extends from the other side. The cut-outs 24a formed in the plug blades 24 make it easier for the synthetic resin to adhere to the plug blades 24 when the inner assembly body 36 is insert-molded with a synthetic resin. As seen from FIG. 4 that shows the inner assembly body 36 viewed from the side on which the cord 26 is attached. The cord bush 26a is sealed and attached to the through-hole formed in the inner case half-body 32.

The AC adapter 20 shown in FIG. 1 is obtained by insert-molding the inner assembly body 36, which is assembled as described above, using a synthetic resin. As a result of the inner assembly body 36 being insert-molded, the outer surface of the case of the inner assembly body 36 is covered so that the case is surrounded by the outer case 22 that is formed by the insert-molding. As a result, the printed circuit board assembly 30 is protected so that the printed circuit board assembly 30 is double-sealed by the inner assembly body 36 and outer case 22. As a result, highly reliable waterproof properties can be obtained.

Since the outer case 22 of the AC adapter 20 is formed by insert-molding using a synthetic resin, the external shape of the outer case 22 can be designed in any configuration as desired with the inner assembly body 36 inside, so that commercial products having various designs can be provided.

Furthermore, when performing insert-molding using a synthetic resin, the metal mold is heated to several hundred degrees Celsius during molding of the resin, and there may be cases in which the resin also reaches a high temperature. Accordingly, the inner assembly body 36, which is a molded part, must have a heat resistance that is able to withstand the metal mold temperature, etc. Consequently, the inner case half-body 32, inner case cover 34, cord bush 26a, etc. have a heat resistance that can withstand insert-molding. With an inner case that has a required heat resistance, the printed circuit board 30 accommodated in the inner case is heat-insulated by the inside air as a result of the inner case having a hollow space; accordingly, damages to the circuit elements, etc. by heat at the time of insert-molding are prevented, and the device can easily be manufactured by resin molding.

In the above-described embodiment, the AC adapter 20 is formed by insert-molding the inner assembly body 36 in which the printed circuit board assembly 30 is sealed by the inner case half-body 32 and the inner case cover 34. However, the inner assembly body 36 is not limited to such a structure.

For example, as shown in FIG. 5, it is possible to fill the inner case half-body 32, in which the printed circuit board assembly 30 is accommodated, with a potting resin 40. In this way, the inner assembly body 36 is formed such that the circuit elements mounted on the printed circuit board assembly 30 are embedded and sealed inside the potting resin 40. In this case, since the circuit elements are sealed by the potting resin 40, the circuit elements are not heated to a high temperature, and the circuit elements are not subjected to thermal damage. Furthermore, by insert-molding the inner assembly body 36 that contains the printed circuit board assembly 30 sealed by the potting resin 40, it is possible to mold the outer case in any desired shape and to perform resin molding without causing any thermal damage to the circuit elements of the printed circuit board assembly 30 at the time of insert-molding.

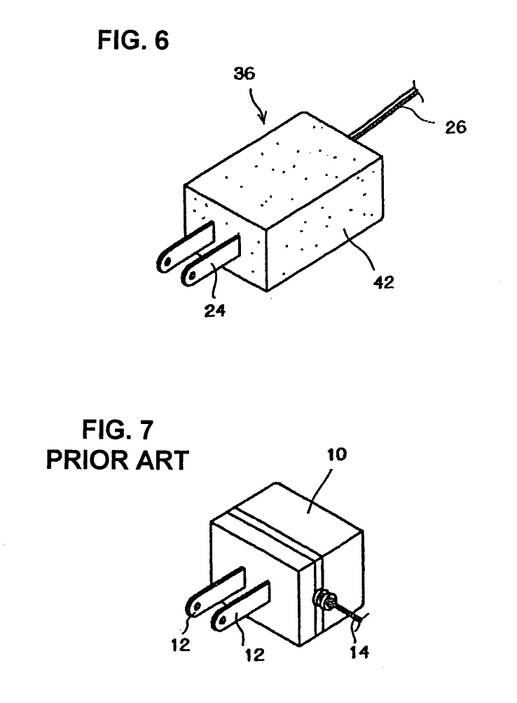

FIG. 6 shows another inner assembly body 36. In this inner assembly body 36, the printed circuit board assembly 30 (not shown) is set in a jig formed in the shape of a case, the case is filled with a potting resin so that the printed circuit board assembly 30 is embedded in the potting resin and molded into a desired shape, and the resulted inner assembly body 36 is removed from the jig following molding. The reference numeral 42 is the potting resin that contains and seals the printed circuit board assembly 30. In this inner assembly body 36 as well, a power supply device can be provided in which the outer surfaces of the potting resin 42 are integrally resin-molded into a desired shape by resin molding using insert-molding in the same manner as in the above-described embodiment.

In the above-described embodiments, the inner assembly body 36 includes the printed circuit board assembly 30, and the plug blades 24 and the cord 26 are connected respectively as a primary-side connecting element and a secondary-side connecting element to this printed circuit board assembly 30. However, the primary-side connecting element and secondary-side connecting element disposed on the power supply device may have different configurations. For example, both the primary-side connecting element and the secondary-side connecting element can be formed as connecting cords, and the secondary-side connecting element can formed as a contact terminal in which an electrical connecting is made by placing the electronic device on this terminal.

The power supply device of the present invention is characterized by the fact that insert-molding that uses a synthetic resin is performed on the inner assembly body 36 so that the outer surfaces of the inner assembly body 36 are covered by an outer case that is formed by the integral molding of a synthetic resin. However, the primary-side connecting element and the secondary-side connecting elements disposed in the power supply device can be formed in various configurations. Furthermore, in the above-described embodiment, an AC adapter is described as an example of the power supply device. However, the construction of the power supply device of the present invention is not limited to an AC adapter, and the present invention can be used in common in various types of power supply devices.

As seen from the above, in the power supply device of the present invention, the external shape of the product can be designed as desired by forming the inner assembly body 36 by resin molding obtained by insert-molding. Furthermore, since the inner assembly body 36 is insert-molded “as is”, the product can be made extremely compact. Moreover, among other advantages, favorable waterproof properties can be obtained with the internal parts such as the printed circuit board assembly 30, etc. being protected by means of a double structure that includes the inner assembly body and outer case.

In the power supply device of the present invention, the inner assembly body is insert-molded. Accordingly, restrictions on the external design of the product are eliminated, and products of various designs can easily be manufactured. Furthermore, among other effects, the device of the present invention can be provided as a highly reliable easy-to-use power supply device that is superior in terms of waterproof properties.

1. A power supply device comprising an inner assembly body that contains a power supply circuit and a primary-side connecting element and a secondary-side connecting element which are electrically connected to said power supply circuit, said inner assembly body being subject to an insert-molding, so that an outer surface of said inner assembly body is covered by a synthetic resin that is formed in integral with said inner assembly body by said insert-molding.

2. The power supply device according to claim 1, wherein said inner assembly body is comprised of an inner case formed by an inner case half-body and an inner case cover so as to have a hollow space therein with said power supply circuit provided therein, and said primary-side connecting element and said secondary-side connecting element are sealed in or integrally attached to said inner case.

3. The power supply device according to claim 1, wherein said inner assembly body is comprised of an inner case half-body in which said power supply circuit is accommodated and is filled with a potting resin so that said power supply circuit is embedded in said potting resin.

4. The power supply device according to claim 1, wherein said inner assembly body is comprised of said power supply circuit embedded in a potting resin that is formed in a desired shape.

5. The power supply device according to claim 1, 2, 3 or 4, wherein said power supply circuit is comprised of a direct current converter circuit provided on a printed circuit board, said direct current converter circuit being at least one selected from the group consisting of a transformer and a diode.
